(19) United States
(12) Patent Application Publication
(10) Pub. No.: US 2012/0297685 A1
(43) Pub. Date: Nov. 29, 2012

(54) PLATFORM SCREEN DOOR DEVICE

(75) Inventors: Makoto KAWAMOTO, Hiroshima (JP); Haretaro HIDAKA, Hiroshima (JP)

(73) Assignee: Mitsubishi Heavy Industries Transportation Equipment Engineering & Service Co., Ltd., Hiroshima (JP)

(21) Appl. No.: 13/477,824

(22) Filed: May 22, 2012

(30) Foreign Application Priority Data
May 26, 2011 (JP) 2011-117838

(51) Int. Cl. E06B 3/46; E06B 5/00

(52) U.S. Cl. 49/372

(57) ABSTRACT

Provided is a platform screen door device capable of reducing total weight of the whole device and securing sufficient strength and durability thereof. The platform screen door device includes a door case provided on a platform; and a sliding door moving in and out of the door case. At least one of the door case and the sliding door includes a frame formed by integrating horizontal door case frame members and vertical door case frame members disposed orthogonally relative to each other, or by integrating horizontal door frame members and vertical door case frame members disposed orthogonally relative to each other, through fastening members using bolts and fixing members using adhesive or the like, supplemental for joint strength of the fastening members using the bolts.

### CROSS-REFERENCE TO RELATED APPLICATIONS

This application claims the benefit of Japanese Patent Application No. 2011-117838, filed on May 26, 2011, which is incorporated herein by reference.

### BACKGROUND OF THE INVENTION

1. The Field of the Invention

The present invention relates to a platform screen door device installed on a platform.

2. The Relevant Technology

A platform screen door device installed on a platform to prevent accidental fall of a passenger includes a door case and a sliding door, and members of the door case and the sliding door are typically made of steel material. Each member is joined to each other by welding.

Japanese Unexamined Patent Application, Publication No. 2009-234373 discloses a platform screen door device in which frames of a door body are made of aluminum or aluminum alloy hollow-extruded members, and a door case body includes a casing and a base supported by the casing, and a motor for driving the door body and a linear motion guide for guiding the door body are supported on this base.

### BRIEF SUMMARY OF THE INVENTION

Members included in a door case and a sliding door of a platform screen door device are typically made of steel material and each member is joined to each other by welding. Thus their weight is relatively heavy. It requires much time to weld them, which increases man-hour for manufacturing, assembling and installing of the platform screen door device. The whole device has such heavy weight that strength reinforcement is required for bolts used for an installation foundation for installing the door case to a platform.

Some existing platforms require a reinforcement work to endure weight of a platform screen door device, and it costs tremendously to install the platform screen door device. In a sliding mechanism of a sliding door in and out of a door case, it is preferred to ensure a smooth movement of the sliding door.

A platform screen door device is required to have sufficient strength for withstanding against a movable load of passengers and luggage on the platform, and wind pressure and vibrations due to running trains.

The present invention has been made in the light of the above facts, and has an object to provide a platform screen door device capable of reducing total weight of the whole device and securing sufficient strength and durability thereof.

To address the above mentioned problems, the platform screen door device according to the present invention employs the following solutions.

The platform screen door device according to the present invention includes a door case installed on a platform and a sliding door moving in and out of the door case, and at least one of the door case and the sliding door is configured to include a frame formed by integrating two stick-like members disposed orthogonally relative to each other through a first fastening member and a first fixing member supplemental for joint strength of the first fastening member.

According to the above described invention, at least one of the door case and the sliding door is configured to include a frame, and the frame includes two stick-like members disposed orthogonally relative to each other. The two stick-like members are integrated through the first fastening member and the first fixing member supplemental for joint strength of the first fastening member, thereby realizing a structure of preventing looseness and position aberration from occurring in the door case and the sliding door.

For example, if the two stick-like members disposed orthogonally relative to each other are integrated through the first fastening member alone, looseness and position aberration between the members are likely to be caused by vibrations resulted from repetitive movements of the sliding door and wind pressures due to running trains. To the contrary, the present invention employs the first fixing member supplemental for the joint strength of the first fastening member, so that it is possible to maintain the integral structure of the two stick-like members disposed orthogonally relative to each other. The fastening member may be joining member for holding two different members therebetween to join the members to each other through bolts, rivets or the like. The fixing member realizes a joint method other than the joint realized by the fastening member, and does not include the fastening member.

In the above described invention, the platform screen door device may further include a reinforcement member disposed along an entire inner circumference of the frame, and the frame and the reinforcement member may be integrated through a second fastening member and a second fixing member supplemental for joint strength of the second fastening member.

According to the above described configuration including the reinforcement member, the reinforcement member is disposed along the entire inner circumference of the frame, thereby enhancing rigidity of the frame. The frame and the reinforcement member are integrated through the second fastening member and the second fixing member supplemental for joint strength of the second fastening member, thereby realizing a structure of preventing looseness and position aberration from occurring in the door case and the sliding door.

In the above described invention, the first fixing member or the second fixing member may be an adhering member or a friction stir welding member.

According to the present invention, the fixing of the two stick-like members in the frame, or the fixing between the frame and the reinforcement member is carried out by the adhering member or the friction stir welding (FSW) member, thereby producing the door case and the sliding door without causing distortion thereto. Particularly, an application of the adhesive facilitates the joint between the two members, which realizes the quick manufacturing and installation of the members.

In the above described invention, the platform screen door device may further include a panel member, and the panel member may be fixed to the frame or to the reinforcement member through a third fixing member that is an adhering member or a friction stir welding member.

According to the above described configuration including the panel member, the panel member is fixed to the frame or to the reinforcement member, thereby enhancing rigidity of the frame. The fixing of the panel member to the frame, or the fixing of the panel member to the reinforcement member is carried out by the adhering member or the friction stir welding (FSW) member, thereby producing the door case and the sliding door without causing distortion thereto. Particularly, the adhering member facilitates the joint between the two members, which realizes the quick manufacturing and installation of the members.

In the above described configuration including the panel member, the panel member may be made of synthetic resin, and a third fixing member may be an adhering member.

In the above described configuration including the panel member made of synthetic resin, the panel member is fixed to the frame or to the reinforcement member through the adhering member, thereby enhancing rigidity of the frame. Synthetic resin material is used for the panel member, thereby reducing total weight of the whole device. In the case of utilizing polycarbonate as the synthetic resin, it is possible to attain greater strength such as an enhanced anti-shock property as well as the weight reduction.

In the above described configuration including the panel member made of synthetic resin, the panel member made of synthetic resin may be transparent.

The panel member fixed to the frame or to the reinforcement member is transparent, thereby attaining transparence effect of functioning as a glass member used in a conventional platform screen door device, and enhancing safety on the platform as well as achieving weight reduction.

In the above described configuration including the reinforcement member, the reinforcement member may include at least two sub-members.

According to the above described configuration of the reinforcement member including at least two sub-members, it is possible to transport the reinforcement member in a divided state, so as to dispose the reinforcement member along the entire inner circumference of the frame. Such a configuration of the reinforcement member is easier to handle, compared to the reinforcement member including a single sub-member.

According to the present invention, it is possible to provide a platform screen door device capable of reducing total weight of the whole device and securing sufficient strength and durability thereof.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a longitudinal sectional view illustrating a platform screen door device according to a first embodiment of the present invention;

FIG. 2 is a cross sectional view illustrating the platform screen door device according to the first embodiment;

FIG. 3 is a longitudinal sectional view illustrating the platform screen door device according to the first embodiment;

FIG. 4 is a front view illustrating the platform screen door device according to the first embodiment;

FIG. 5 is a cross sectional view illustrating a joint portion of a horizontal door frame member, a reinforcement member and a panel member of the platform screen door device according to the first embodiment;

FIG. 6 is a cross sectional view illustrating a modified example of the joint portion of the horizontal door frame member, the reinforcement member and the panel member of the platform screen door device according to the first embodiment;

FIG. 7 is a cross sectional view taken along line B-B of FIG. 1;

FIG. 8 is a longitudinal sectional view of a platform screen door device according to a second embodiment of the present invention;

FIG. 9 is a cross sectional view of the platform screen door device according to the second embodiment.

### DETAILED DESCRIPTION OF THE PREFERRED EMBODIMENTS

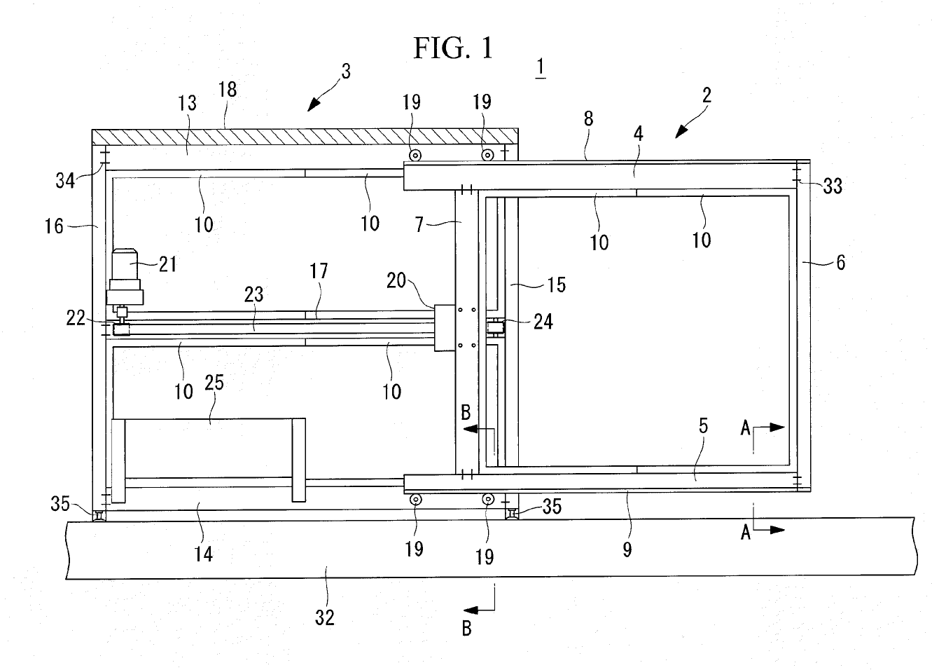

Hereinafter, descriptions will be provided on a platform screen door device 1 according to the first embodiment of the present invention with reference to FIG. 1 to FIG. 4.

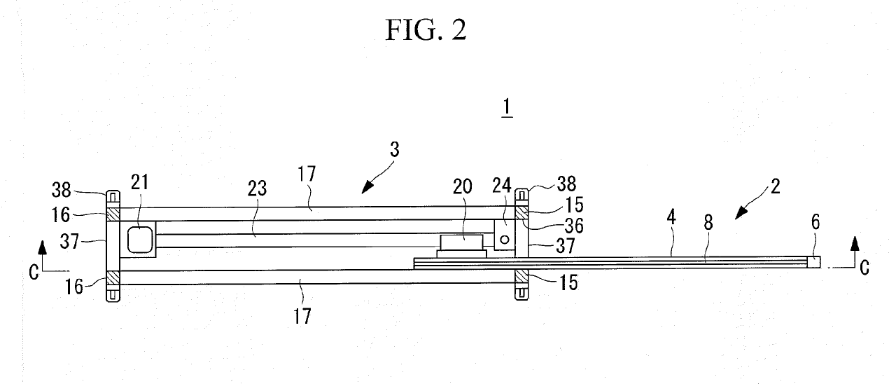

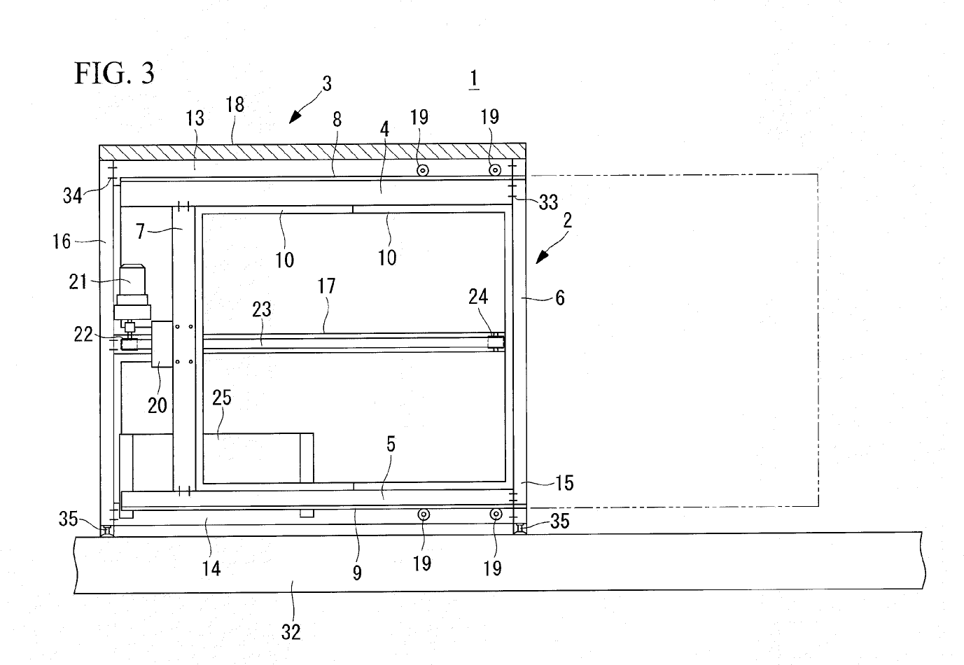

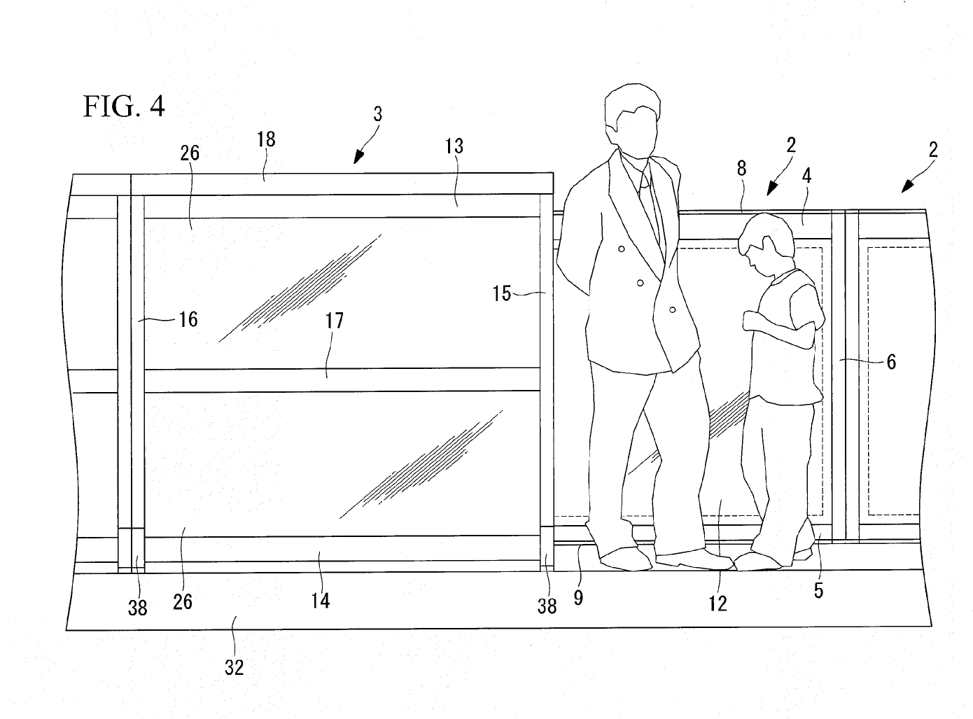

FIG. 4 illustrates an installation state of the platform screen door device 1 in a closed state, viewed from the inside of a platform 32. FIG. 1 is a cross sectional view taken along line C-C of FIG. 2, and illustrates the platform screen door device 1 of FIG. 4 with a door panel 12 of the sliding door 2 and a door case panel 26 of the door case 3 removed. FIG. 1 and FIG. 2 illustrate the platform screen door device 1 in the closed state with the sliding door 2 out of the door case 3. FIG. 3 illustrates the platform screen door device 1 in an open state with the sliding door 2 housed in the door case 3. Two units of the platform screen door devices 1 illustrated in FIG. 1 to FIG. 4 may be symmetrically disposed on both right and left sides so as to open or close the sliding doors 2 on both sides on the platform 32, or a single unit of the platform screen door device 1 may be disposed so as to open or close the door 2 on one side.

The platform screen door device 1 has a half-height platform screen door with a height of about 1.3 m to 1.4 m from an installation level on the platform 32 to an upper end of a top plate 18. The platform screen door device 1 includes the sliding door 2 and the door case 3, and the sliding door 2 slidingly moves in and out of the door case 3.

The sliding door 2 will now be described.

Horizontal door frame members 4, 5 and vertical door frame members 6, 7 are stick-like members made of light metal or light alloy such as aluminum or aluminum alloy, and may be formed by extruding, for example. A frame is formed by the horizontal door frame members 4, 5 and the vertical door frame members 6, 7.

The horizontal door frame members 4, 5 and the vertical door frame members 6, 7, are disposed orthogonally relative to each other, and are joined to each other through bolts 33 and an adhesive, so as to form an integrated frame. The bolt 33 is inserted from the outside into the inside of one frame in a direction indicated by abbreviated reference signs in FIG. 1, for example, so as to fasten both frame members to each other. The abbreviated reference signs of the bolts 33 in FIG. 1 are illustrated on surfaces of the horizontal door frame members 4, 5 and the vertical door frame members 6, 7, but the bolts 33 are actually inserted in the vicinity of centers of cross sections of the horizontal door frame members 4, 5 and the vertical door frame members 6, 7. The adhesive is applied to joint portions in contact between the horizontal door frame members 4, 5 and end surfaces of the vertical door frame member 7, and also between the horizontal door frame members 4, 5 and side surfaces of the vertical door frame member 6, so as to join these frame members to each other.

The above described frame is formed by integrating the horizontal door frame members 4, 5 and the vertical door frame members 6, 7 through the joint using the bolts 33 and the adhesive supplemental for the joint strength of the bolts 33, thereby realizing a structure of preventing looseness and position aberration from occurring in the door case 3 and the sliding door 2.

If the horizontal door frame members 4, 5 are orthogonally integrated with the vertical door frame members 6, 7 through the joint using the bolts 33 alone, for example, the bolts 33 are likely to be loosened or receiving holes of the bolts 33 are likely to become larger due to vibrations resulted from repetitive movements of the sliding door 2 and wind pressures caused by running trains, which causes looseness and position aberration between the frame members. To the contrary, application of the adhesive can supplement the joint strength of the bolts 33, and can maintain the integral structure of the horizontal door frame members 4, 5 and the vertical door frame members 6, 7 even if looseness or position aberration of the bolts 33 occurs.

Instead of using the bolts 33, other fastening members such as rivets may be applicable to the joint between the horizontal door frame members 4, 5 and the vertical door frame members 6, 7. The fastening member serves for joining two different members. Instead of using the supplemental adhesive along with the fastening member, other fixing member such as friction stir welding (FSW) may be applicable. The fixing member realizes a joint method other than the joint realized by the fastening member, and does not include the fastening member. The fixing member such as adhesive and friction stir welding can produce the door case 3 and the sliding door 2 without causing distortion thereto. Particularly, an application of the adhesive facilitates the joint between the two members, which realize the quick manufacturing and installation of the members.

A rail 8 is installed along an upper end of the horizontal door frame member 4, and a rail 9 is installed along a lower end of the horizontal door frame member 5. The rails 8, 9 come into contact with rollers 19 so that the sliding door 2 can move smoothly.

A reinforcement member 10 is disposed along the entire inner circumference of the frame formed by the horizontal door frames members 4, 5 and the vertical door frames members 6, 7. This reinforcement member 10 secures rigidity of the frame. If the horizontal door frame members 4, 5 and the vertical door frame members 6, 7 are joined only at each corner of the frame, rigidity of the frame becomes small, so that the movement of the sliding door 2 relative to the door case 3 becomes unstable; however, the rigidity of the frame can be secured by providing the reinforcement member 10, which enables stable and smooth movement of the sliding door 2.

The reinforcement member 10 may include at least two sub-members in one frame, as illustrated in FIG. 1 and FIG. 3. The example of FIG. 1 and FIG. 3 shows that the reinforcement member 10 includes two sub-members, and each sub-member of the reinforcement member 10 has a U shape viewed from the front, and is disposed symmetrically. The reinforcement member 10 has a hollow square shape when the sub-members are assembled into the reinforcement member 10, thereby securing greater adhesion area for joining the door panel 12 to the reinforcement member 10 with the adhesive. Accordingly the inside of the frame includes fewer sub-members, which simplifies a shape of an aperture, thereby enhancing appearance of the inside of the sliding door 2 when the door panel 12 is formed by a transparent member, and also securing visibility on the platform so as to enhance safety. Further, the number of the sub-members is small, which realizes a quick and easy assembly of the sliding door 2. Each sub-member of the reinforcement member 10 may have an L shape viewed from the front, and form a hollow square shape when the four sub-members are assembled into the reinforcement member 10.

The door panel 12 has a rectangular shape and is made of synthetic resin such as polycarbonate. The door panel 12 is fixed to the reinforcement member 10 with the adhesive. The door panel 12 may be fixed to the frame. Using a transparent member for the door panel 12 achieves weight reduction as well as transparence effect of functioning as a glass member used in a conventional platform screen door device.

Fixing the door panel 12 to the frames and the reinforcement member 10 of the sliding door 2 can enhance rigidity of the sliding door 2. The door panel 12 may be made of light metal or light alloy such as aluminum or aluminum alloy.

A configuration of the door case 3 will now be described.

Horizontal door case frame members 13, 14 and vertical door case frame members 15, 16 are stick-like members formed by extruding light metal or light alloy such as aluminum or aluminum alloy, for example. The horizontal door case frame members 13, 14 and the vertical door case frame members 15, 16 are disposed orthogonally relative to each other, and are joined through bolts 34 and the adhesive into an integrated frame, as similar to the joint between the horizontal door frame members 4, 5 and the vertical door frame members 6, 7. The above described two frames are joined into a box-like structure through the frame-coupling members 37. Lower ends of the vertical door case frame members 15, 16 are provided with adjusters 35 and legs 38, and are installed on the platform 32.

The reinforcement member 10 may be provided along the entire inner circumferences of the respective horizontal door case frame members 13, 14 and the vertical door case frame members 15, 16, as similar to the horizontal door frame members 4, 5 and the vertical door frame members 6, 7. This reinforcement configuration enhances the strength of the door case 3, and secures a greater adhesion area for joining the door case panel 26 to the reinforcement member 10 with the adhesive.

A horizontal reinforcement member 17 is so disposed at a center between the vertical door case frame members 15, 16, where the horizontal reinforcement member 17 is connected to the vertical door case frame members 15, 16. The top plate 18 is disposed along an upper end of the horizontal door case frame member 13.

The two rollers 19 are provided for each of the horizontal door case frame members 13, 14, for example. The sliding door 2 is supported by the rollers 19 located at the upper and the lower ends of the sliding door 2. Since weight reduction and rigidity enhancement are attained in the sliding door 2, the sliding door 2 supported by the rollers 19 can move smoothly. A conventional platform screen door device adopts a linear guide as its sliding mechanism, and the accuracy of a sliding door relative to a door case should be increased in an application of such a linear guide. To the contrary, weight reduction is achieved in the sliding door 2 in the present embodiment, it is unnecessary to secure the accuracy of the sliding door 2 relative to the door case 3 for the linear guide, and the sliding door 2 can be movably supported by the rollers 19.

A base 20 is a member fixed to the vertical door frame member 7, and is attached to a belt 23. When the belt 23 moves, the base 20 also moves along with the movement of the belt 23 so as to move the entire sliding door 2.

A motor 21 is a driving source for driving the belt 23. The motor 21 is connected to a pulley 22. A pulley 24 is disposed on the opposite side of the motor 21. The belt 23 is rotated having the pulley 22 and the pulley 24 at its respective ends.

A controller 25 controls the sliding door 2 to move and stop. The controller 25 sends a driving signal to the motor 21 in response to a driving command regarding movement and stop. In this way, the movement of the sliding door 2 is controlled by the controller 25.

The door case panel 26 has a rectangular shape, and is made of synthetic resin such as polycarbonate. The door case panel 26 is fixed to the frames of the door case 3, thereby enhancing rigidity of the door case 3.

The sliding door 2 moves in and out of the aperture 36 provided to the door case 3. The aperture 36 is formed in an inner portion of the frame created by the vertical door case frame member 15 and the frame-coupling members 37.

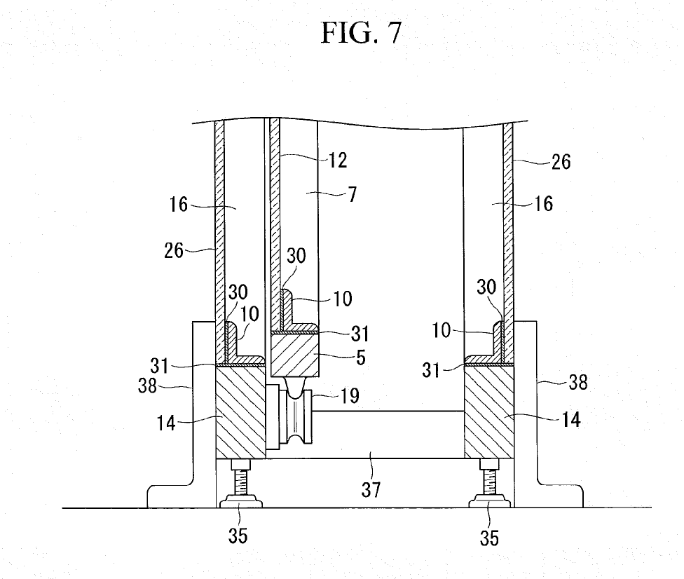

Both sliding door 2 and door case 3 are made of lightweight members, thereby realizing weight reduction of the entire platform screen door device 1. As a result, it is possible to facilitate manufacturing and installation of the platform screen door device 1 as well as to reduce reinforcement to be required for the platform 32 that is the installation site. Weight reduction enables the adjusters 35 to be used through a thread connection on the lower surface of the platform screen door device 1, so as to readily adjust the height of the platform screen door device 1 at the time of installing the device, as illustrated in FIG. 7. After the height adjustment by the adjusters 35, the legs 38 are attached at side surfaces of the vertical door case frame members 15, 16, and anchor bolts (not illustrated) are inserted through the legs 38 and fastened and secured to the platform 32. Such weight reduction allows anchor bolts having smaller strength to be used for the installation foundation.

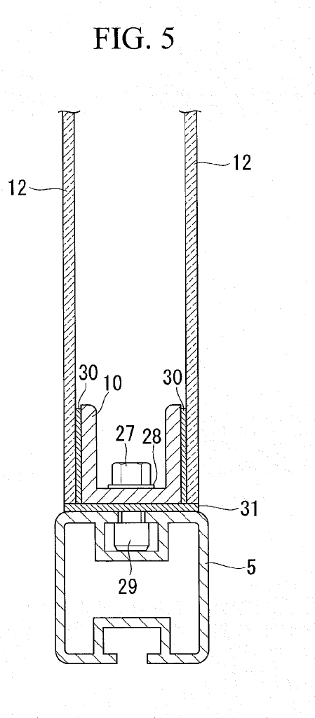

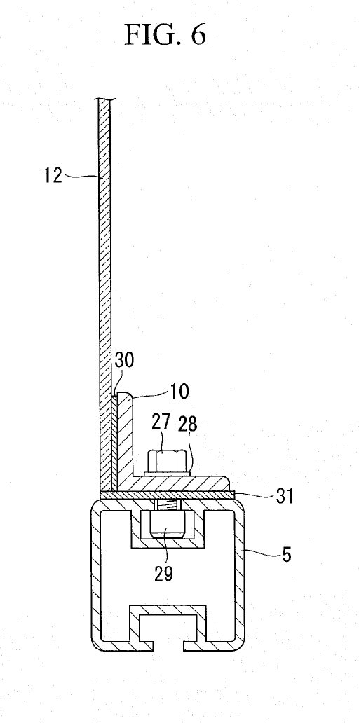

With reference to FIG. 5 and FIG. 6, descriptions will be provided on the joint portion between the horizontal door frame member 5 and the door panel 12 of the platform screen door device 1. FIG. 5 illustrates an installation state of the door panel 12 on both sides of the sliding door 2, and FIG. 6 illustrates an installation state of the door panel 12 on one side of the sliding door 2. FIG. 5 and FIG. 6 are cross sectional views taken along line A-A of FIG. 1.

The horizontal door frame member 5 is an extruded member, and is provided with a nut groove. The nuts 29 are inserted in the nut groove, so as to fix the reinforcement member 10 to the horizontal door frame member 5 through bolts 27 and washers 28. As illustrated in FIG. 5, the reinforcement member 10 may be a member having a U-shaped cross section, or having an L-shaped cross section as illustrated in FIG. 6. An adhesive 31 is used for fixing the reinforcement member 10 to the horizontal door frame member 5, as illustrated in FIG. 5 and FIG. 6. The door panel 12 is fixed to the reinforcement member 10 using an adhesive 30.

Different from a welded structure of a conventional platform screen door device, according to the joint portion between the horizontal door frame member 5 and the door panel 12 of the present embodiment, it is possible to readily assemble the sliding door 2 by using the horizontal door frame member 5 of an extruded member, the door panel 12 made of synthetic resin, the bolts 27 and the adhesives 30, 31. The horizontal door frame member 5 and the reinforcement member 10 are integrated through the joint of the bolts 27 and the nuts 29 as well as the adhesive supplemental for joint strength between the bolts 27 and the nuts 29, thereby realizing a structure of preventing looseness and position aberration from occurring in the door case 3 and the sliding door 2.

Other fastening members and fixing members may be applicable, as similar to the above described case of the joint between the horizontal door frame members 4, 5 and the vertical door frame members 6, 7. The relation between the reinforcement member 10 and the horizontal door frame member 5 that has been described with reference to FIG. 5 and FIG. 6 may also be applicable to the horizontal door frame member 4 and the vertical door frame members 6, 7. Addition to this, the relation between the reinforcement member 10 and the horizontal door frame member 5 and the relation between the reinforcement member 10 and the door panel 12 may also be applicable to the frames of the door case 3 and the door case panel 26 in the same manner.

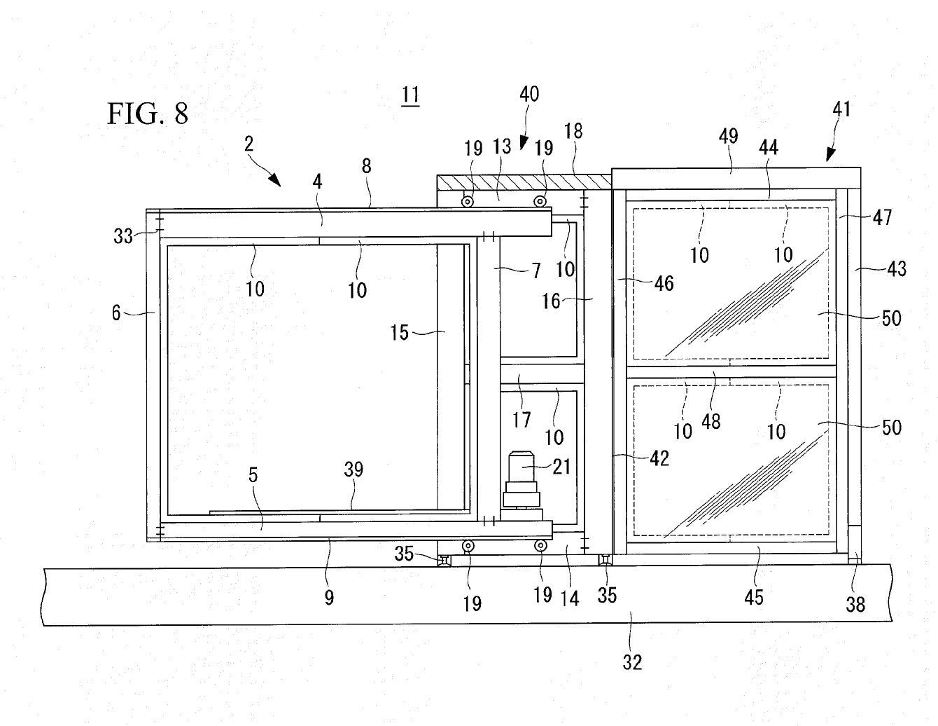

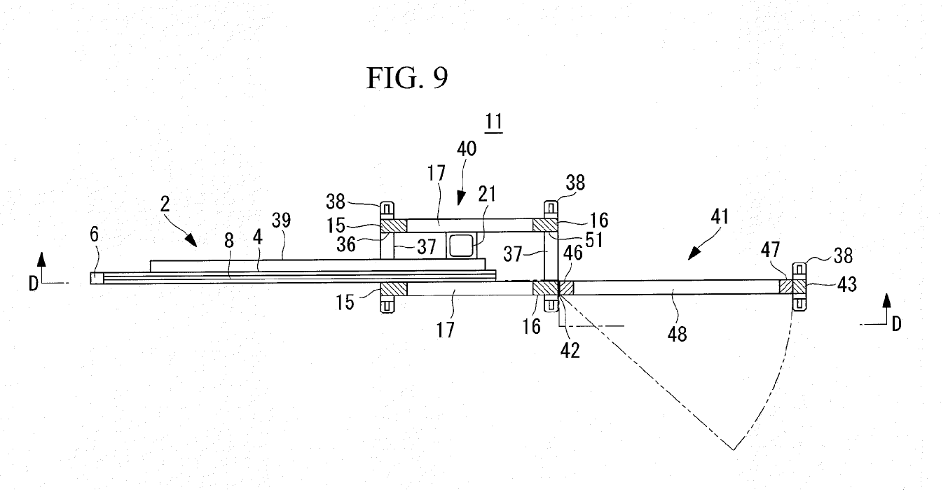

A platform screen door device 11 according to the second embodiment of the present invention will now be described with reference to FIG. 8 and FIG. 9. FIG. 8 is a cross sectional view taken along line D-D of FIG. 9, and illustrates the platform screen door device 11 with the door panel 12 of the sliding door 2 and the door case panel 26 of the door case 3 removed.

The platform screen door device 11 includes the sliding door 2, a door case 40 and an emergency door 41. The sliding door 2 has the same structure as the above described structure other than a driving mechanism described later, therefore, detailed descriptions thereof will be omitted.

The door case 40 includes the horizontal door case frame members 13, 14 having shorter lengths compared to those of the door case 3, and the rest of the length is reserved for accepting the emergency door 41. The door case 40 is provided with the aperture 37 through which the sliding door 2 can pass. The aperture 37 is formed in an inner portion of the frame created by the vertical door case frame member 16 and the frame-coupling member 37.

The sliding door 2 is moved by a rack and pinion driving mechanism. A rack 39 is installed at a lower position of the sliding door 2 along the moving direction of the sliding door 2, and this rack 39 comes into mesh with a pinion (not illustrated) provided to the motor 21. The motor 21 drives to move the sliding door 2 in and out of the door case 40. The sliding door 2 may be driven by the belt mechanism as described in the first embodiment.

The door portion of the emergency door 41 is turned about a hinge 42 inward of the platform 32, so as to come into an open state (two-dot chain line of FIG. 9). The emergency door 41 is normally locked by an interlock mechanism to be maintained in a closed state, and is unlocked from the closed state and comes into an open state at an emergency time. Accordingly, at an emergency time such as an urgent time or breakdown, passengers can take refuge from the trains to the platform 32. As illustrated in FIG. 8, the door portion of the emergency door 41 is surrounded by a support 43 and a top plate 49, and includes horizontal emergency door frame members 44, 45, vertical emergency door frame members 46, 47, horizontal reinforcement member 48, the reinforcement member 10 and an emergency door panel 50, for example.

As described above, in the present embodiment of the present invention, the horizontal door frame members 4, 5 and the vertical door frame members 6, 7 both of which are made of aluminum or aluminum alloy are joined to each other by bolting as well as using the adhesive, so as to form the sliding door 2, for example. Furthermore, the horizontal door case frame members 13, 14 and the vertical door case frame members 15, 16 both of which are made of aluminum or aluminum alloy are joined to each other by bolting as well as using the adhesive, so as to form the door cases 3, 40, for example.

Using the frames made of aluminum or aluminum alloy and the panel members made of synthetic resin can realize reduction of the total weight of the platform screen door devices 1, 11. Accordingly, it is possible to facilitate the assembly and installation of the platform screen door devices 1, 11. Employing the frames made of aluminum or aluminum alloy can prevent the platform screen door device 1 from being corrode. The simplified structure facilitates disassemble of the platform screen door device 1, so that it is possible to readily disassemble the platform screen door device 1 once assembled in a factory, and to transport this to an installation site, as well as to readily repair the platform screen door device 1 at the time of breakage. Furthermore, the weight reduction of the platform screen door devices 1, 11 is attained, thereby eliminating or reducing a reinforcement work of the platform in order to install the platform screen door devices 1, 11, as well as allowing the bolts having smaller strength to be used for the installation foundation of the door cases 3, 40.

The frames of the sliding door 2 and the door cases 3, 40 are reinforced by the reinforcement member 10, the door panel 12 and the door case panel 26. The reinforcement of the frames requires the smaller number of the sub-members, and the bolts and the adhesives are used at the joint portions of the frames, thereby enhancing the workability and providing excellent appearance. Further, it is possible to secure strength and rigidity of the sliding door 2 and the door cases 3, 40. As a result, strength and durability can be secured in the platform screen door devices 1, 11, which enables the platform screen door devices 1, 11 to withstand against a movable load of passengers and luggage on the platform 32, and wind pressure and vibrations due to running trains, as well as to smoothly move the sliding door 2 relative to the door cases 3, 40.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A platform screen door device comprising:
a door case; and
a sliding door moving in and out of the door case, wherein at least one of the door case and the sliding door is configured to include a frame formed by integrating two stick-like members disposed orthogonally relative to each other through a first fastening member and a first fixing member supplemental for joint strength of the first fastening member.

2. The platform screen door device according to claim 1, wherein
the platform screen door device further comprises a reinforcement member disposed along an entire inner circumference of the frame, and
the frame and the reinforcement member are integrated through a second fastening member and a second fixing member supplemental for joint strength of the second fastening member.

3. The platform screen door device according to claim 1, wherein
the first fixing member is as adhering member or a friction stir welding member.

4. The platform screen door device according to claim 2, wherein
the second fixing member is as adhering member or a friction stir welding member.

5. The platform screen door device according to claim 1, wherein
the platform screen door device further comprises a panel member, and
the panel member is fixed to the frame through a third fixing member that is an adhering member or a friction stir welding member.

6. The platform screen door device according to claim 2, wherein
the platform screen door device further comprises a panel member, and
the panel member is fixed to the reinforcement member through a third fixing member that is as adhering member or a friction stir welding member.

7. The platform screen door device according to claim 5, wherein
the panel member is made of synthetic resin, and is fixed to the frame through the third fixing member that is an adhering member.

8. The platform screen door device according to claim 6, wherein
the panel member is made of synthetic resin, and is fixed to the reinforcement member through the third fixing member that is an adhering member.

9. The platform screen door device according to claim 7, wherein
the panel member is transparent.

10. The platform screen door device according to claim 8, wherein the panel member is transparent.

11. The platform screen door device according to claim 2, wherein the reinforcement member includes at least two sub-members.
